(19) United States
(12) Patent Application Publication
(10) Pub. No.: US 2014/0130678 A1
(43) Pub. Date: May 15, 2014

(54) CAPSULE FOR PRESSURIZED DRINK EXTRACTION

(71) Applicant: Alain Frydman, Paris (FR)

(72) Inventor: Alain Frydman, Paris (FR)

(21) Appl. No.: 14/123,204

(22) PCT Filed: Jun. 14, 2011
(86) PCT No.: PCT/FR2011/051348

§ 371 Date: Jan. 29, 2014

(30) Foreign Application Priority Data
Jun. 1, 2011 (EP) 11305679.0
Jun. 1, 2011 (EP) 11305680.8

(51) Int. Cl. B65D 85/804; A47J 31/40

(52) U.S. Cl. CPC B65D 85/8043; A47J 31/407
USPC 99/295; 426/115

(57) ABSTRACT

The capsule (2002) according to the invention comprises a side wall (2006) extending along a longitudinal axis (X-X), an inlet wall (2008) closing a first rear end of the side wall (2006), and an outlet wall (2010) closing a second front end of the side wall (2006), delimiting a chamber (2014) for receiving a substance for preparing a drink. According to one aspect of the invention, the outlet wall (2010) and the inner surface (2028) of the side wall (2006) comprise complementary raised snapping portions making it possible to snap the outlet wall (2010) in the front end of the side wall (2006). Applicable to capsules for extracting coffee, tea, hot chocolate, etc.

The present invention relates to a capsule for extracting a pressurized drink, of the type comprising a cup-shaped body and a cap together delimiting a chamber containing a substance for preparing a drink, the body comprising a substantially tapered outer side wall and a bottom integral with the side wall and forming the outer side wall at a rear end of the body, the cap closing the outer side wall at the front end of the body, the capsule being suitable for being positioned in an extraction device such that a pressurized extraction liquid penetrates the capsule through the bottom and leaves it through the cap.

FR 2,373,999 describes such a capsule designed to be used in a drink extraction device, so as to produce a drink such as coffee.

There is a risk of such a capsule collapsing during closing of the drink extraction device and/or the injection of pressurized liquid.

Furthermore, such capsules are particularly expensive to produce, in particular when they are produced in large series.

Lastly, when such a capsule is used in an extraction device including a housing for receiving the capsule and a support against which the capsule is applied, the cap is pressed against the support, which prevents a satisfactory flow of liquid through the capsule.

One aim of the present invention is to provide a capsule making it possible to limit the risk of collapse while allowing extraction of a drink. Other aims of the invention are to propose a capsule that can be calibrated easily so as to adjust the pressure level at which the extraction liquid penetrates the capsule, to propose a capsule at a reduced cost, and to provide a capsule that is compatible with many drink extraction devices.

To that end, a first aspect of the invention relates to a capsule of the aforementioned type, in which the bottom is formed by a peripheral region delimiting a rear end of the body, and by a central region drawing in toward the inside of the capsule relative to the rear end while defining a recess outside the body, the central region comprising at least one area of least resistance provided to break at least partially under the pressure of a pressurized liquid.

According to other embodiments, the capsule includes one or more of the following features, considered alone or according to any technically possible combination(s):
the central region comprises a bottom portion and a central stud protruding from the bottom portion toward the outside,
the central region comprises an annular rib protruding toward the inside of the body, the recess assuming the shape of an annular edge outside the body,
the central region comprises a flat bottom portion axially closing the recess,
the or each region of least resistance is formed in the bottom portion,
the bottom comprises at least one reinforcing rib of the central region,
the body comprises at least one radial rib for stiffening the peripheral region,
before breaking the or each area of least resistance, the bottom and the outer side wall of the body are impermeable to air and liquids,
the central stud has a tapered shape,
the central stud has a hemispherical shape,
the cap comprises a filter and a membrane,
the filter is set back from the front end of the body, toward the chamber, the membrane extending along the front end,
the space between the filter and the membrane is filled with nitrogen,
the membrane is strippable,
the outer side wall and the bottom are formed by a first plastic material, and the body comprises an annular rim extending radially toward the outside from the outer side wall and delimiting the front end of the body, said annular rim being formed from a second plastic material, different from the first plastic material,
the central region comprises a tubular outer part extending axially toward the inside of the chamber from the peripheral region, the or each area of least resistance being formed at the junction between the bottom portion and the outer portion,
the or each area of least resistance is suitable for breaking at a pressure of the pressurized liquid comprised between 1 and 3 bars.

A second aspect of the invention relates to a capsule for extracting a pressurized drink, of the type comprising a cup-shaped body and a cap delimiting a chamber containing a substance for preparing a drink, the body comprising a substantially tapered side wall and a bottom integral with the side wall enclosing the side wall at one end, the cap closing the other end of the side wall, the capsule being suitable for being positioned in an extraction device such that a pressurized extraction liquid penetrates the capsule through the bottom and leaves it through the cap, characterized in that the bottom includes a central region including an annular reinforcing rib of the bottom protruding toward the inside of the body and delimiting an annular trench at the outside of the body.

According to other embodiments, said capsule includes one or more of the following features, considered alone or according to any technically possible combination(s):
the central region has at least one area of least resistance provided to break at least partially under the pressure of a pressurized liquid;
the annular rib has a U-shaped cross-edge defined by two side portions connected by a base, at least one weak zone being defined in the base;
the annular rib defines a central stud surrounded by the annular edge, the central stud comprising at least one area of least resistance;
the bottom comprises a rounded peripheral region whereof the concave side is turned toward the inside of the body;
the bottom and the side wall of the body are airtight and watertight;
the body includes an annular rim extending radially toward the outside from the side wall, the rim defining one end of the capsule opposite the bottom;
the cap comprises a filter;
the cap comprises an airtight and watertight membrane; and
the membrane is provided with weakening lines for opening the membrane under the effect of only the pressure from a pressurized fluid.

A third aspect of the invention relates to a capsule for extracting a pressurized drink, of the type comprising a cup-shaped body and an outlet filter delimiting a chamber containing a substance for preparing a drink, the capsule comprising a sealed outlet membrane, the body comprising a bottom delimiting a rear end of the body and a substantially tapered side wall extending from the bottom to an open front end of the body, the membrane closing the front end, the capsule being suitable for being positioned in an extraction device such that a pressurized extraction liquid penetrates the capsule through the bottom and leaves it through the outlet membrane, characterized in that the filter and the membrane are positioned set back relative to the front end of the body.

According to other embodiments, said capsule includes one or more of the following features, considered alone or according to any technically possible combination(s):
the side wall includes an inner shoulder set back relative to the front end of the body, the filter and the membrane being fastened on the inner shoulder;
the distance of the outlet membrane to the front end is greater than 1 mm;
the outlet membrane is airtight and watertight;
the outlet membrane is capable of tearing under the effect of only the pressure from a liquid, so as to allow a liquid passing through the capsule to exit;
the outlet member includes at least one rupture line;
the outlet filter is positioned between the chamber and the outlet membrane;
the filter and the outlet membrane are alongside one another;
the outlet filter is made from a woven or perforated plastic material; and
the membrane is a plastic or metal film, in particular aluminum.

A fourth aspect of the invention relates to a system comprising a capsule according to the first, second or third embodiment of the invention, and an extraction device including a housing designed to receive the capsule, a support and an extraction liquid intake line.

A fifth aspect of the invention relates to a system, of the type comprising a device for extracting a drink and a capsule for extracting a pressurized drink, the capsule comprising a cup-shaped body and a cap delimiting a chamber containing a substance for preparing a drink, the body comprising a substantially tapered side wall and the bottom closing the side wall at one end, the cap closing the other end of the side wall, the capsule being suitable for being positioned in the extraction device such that a pressurized extraction liquid penetrates a capsule through the bottom and leaves it through the cap, the drink extraction device including an element for receiving a capsule having an inner side face, characterized in that the capsule is suitable for the bottom to produce a contact against the receiving element along a closed annular contact line.

According to other embodiments, said system includes one or more of the following features, considered alone or according to any technically possible combination(s):
the capsule and the receiving element are configured so that the receiving element exerts a compression force on the bottom of the capsule, the bottom and/or the side wall of the capsule being suitable for deforming under the effect of that force;
the side wall and/or the bottom of the body expand radially under the effect of the force exerted by the receiving element of the extraction device, so as to provide contact between the side wall of the body of the capsule and the inner side face of the receiving element;
the bottom of the body of the capsule comprises a rounded peripheral region whereof the concave side is turned toward the inside of the body;
the bottom of the capsule comprises an annular peripheral region and a central region comprising an annular trench, the contact line being defined over the peripheral region;
the contact line is defined by an outer edge of the trench at the junction between the trench and the peripheral region;
the outer edge of the trench is angular;
the body of the capsule includes an annular rim at the end of the side wall opposite the bottom, the annular rim being at least partially inclined toward the front of the capsule, on the side opposite the bottom;
the rim of the body of the capsule is tapered, widening toward the front; and
the rim of the body of the capsule is curved toward the front.

A sixth aspect of the invention relates to a capsule for extracting a pressurized drink, of the type comprising a cup-shaped body and a cap delimiting a chamber containing a substance for preparing a drink, the body comprising a substantially tapered side wall and a bottom closing the side wall at a first end, the cap closing the second end of the side wall, the capsule being suitable for being positioned in the extraction device such that a pressurized extraction liquid penetrates the capsule through the bottom and leaves it through the cap, characterized in that the capsule is suitable for the bottom to produce contact against a capsule receiving element of an extraction device, along a closed annular contact line.

According to other embodiments, said capsule includes one or more of the following features, considered alone or according to any technically possible combination(s):
the capsule is adapted so that, when an axial force is applied on the bottom of the body, at least one annular zone of the side wall and/or the bottom expands radially outwardly;
the bottom of the body of the capsule comprises a rounded peripheral region whereof the concave side is turned toward the inside of the body;
the bottom is suitable for deforming under the effect of the force exerted axially thereon;
the bottom of the capsule comprises an annular peripheral region and a central region comprising an annular trench, the contact line being defined over the peripheral region;
the contact line is defined by an outer edge of the trench at the junction between the trench and the peripheral region;
the outer edge of the trench is angular;
the body of the capsule includes an annular rim at the end of the side wall opposite the bottom, the annular rim being at least partially inclined toward the front of the capsule, on the side opposite the bottom;
the rim of the body of the capsule is tapered, widening toward the front;
the rim of the body of the capsule is curved toward the front; and
the body is made in a single piece made from plastic material or a plastic derivative, or from metal.

A seventh aspect of the invention relates to an extraction method using the system according to the fifth aspect of the invention, characterized in that the method includes the following steps:
installing the capsule in the drink extraction device;
using the receiving element of the extraction device to apply a force (F) on the bottom of the capsule;
deforming the bottom and/or the side wall of the body of the capsule, part of the bottom and/or the side wall producing contact along a closed line with the receiving element of the extraction device; and
injecting extraction liquid in the capsule, using liquid injection means of the extraction device.

An eighth aspect of the invention relates to a capsule for extracting a drink, of the type comprising a side wall extending along an axis, an inlet wall closing a first end of the side wall and an outlet wall closing a second end of the side wall, delimiting a chamber for receiving a substance for preparing a drink, characterized in that the inlet wall is provided to break under the effect of a pressurized fluid and comprises a bottom portion and an area of least resistance provided to break under the effect of a pressurized fluid situated at the periphery of the bottom portion.

According to other embodiments, the capsule includes one or more of the following features, considered alone or according to any technically possible combination(s):
the area of least resistance extends axially;
the bottom portion is positioned axially set back toward the inside of the capsule relative to a peripheral portion of the inlet wall;
the inlet wall comprises an axial portion extending along the axis while drawing in toward the inside of the capsule, the periphery of the bottom portion being connected to an axial end of the axial portion situated toward the inside of the capsule, by the area of least resistance;
the area of least resistance axially extends the axial portion;
the area of least resistance has a thickness smaller than that of the axial portion;
the bottom portion is a dome;
the dome has a concave side turned toward the inside of the capsule;
the dome is sudden-acting and provided to reverse abruptly under the effect of a pressurized fluid;
the outlet wall and the side wall comprise complementary raised snapping portions;
the outlet wall comprises a fastening rib provided on an edge of the outlet wall and the inner surface of the side wall comprises a complementary fastening groove;
the outlet wall comprises a peripheral fastening frame and a filter extending through the frame;
the filter comprises orifices;
the frame and the filter are integral or the frame is attached on the filter;
it comprises a sealing membrane covering the outlet wall;
it comprises an annular rim surrounding the second end of the side wall and extending radially toward the outside from the second end of the side wall, the side wall and the inlet wall being integral and made from a first material, and the rim being formed from a second plastic material, different from the first plastic material; and
the side wall and the inlet wall are integral and define a body made in a single piece in the shape of a cup.

The invention also relates to a system comprising a capsule as defined above and an extraction device including a housing designed to receive the capsule and an intake line for bringing pressurized extraction liquid into the housing.

A ninth aspect of the invention relates to a capsule for extracting a drink, of the type comprising a side wall extending along an axis, an inlet wall closing a first end of the side wall and an outlet wall closing a second end of the side wall, delimiting a receiving chamber for receiving a substance for preparing a drink, characterized in that the outlet wall and the inner surface of the side wall comprise complementary raised snapping portions for fastening the outlet wall on the side wall.

According to other embodiments, the capsule includes one or more of the following features, considered alone or according to any technically possible combination(s):
the outlet wall comprises an annular fastening rib provided on an edge of the outlet wall and the inner surface of the side wall comprises a complementary fastening groove;
the outlet wall comprises a peripheral fastening frame and a filter extending through the frame;
the filter comprises orifices;
the frame and the filter are integral;
the frame is attached on the filter;
the frame is overmolded on a marginal region of the filter;
the frame is thicker than the filter;
the filter is set back toward the inside of the capsule relative to an outer face of the frame;
the inlet wall is provided to break under the effect of a pressurized fluid;
the inlet wall comprises a dome whereof the concave side is turned toward the inside of the capsule and an area of least resistance on the periphery of the dome provided to break under the effect of a pressurized fluid;
the dome is sudden-acting and can reverse abruptly under the effect of a pressurized fluid;
the dome is positioned set back toward the inside of the capsule relative to a peripheral portion of the inlet wall;
the dome extends transversely to the axis and the area of least resistance extends axially along the axis; and
it comprises an annular rim surrounding the second end of the side wall and extending radially toward the outside from the second end of the side wall, the side wall and the inlet wall being integral and made from a first material, and the rim being made from a second plastic material, different from the first plastic material.

The invention also relates to a system comprising a capsule as defined above and an extraction device including a housing designed to receive the capsule and an intake line for bringing pressurized extraction liquid into the housing.

The invention will be better understood upon reading the following description, provided solely as an example and done in reference to the appended drawings, in which:

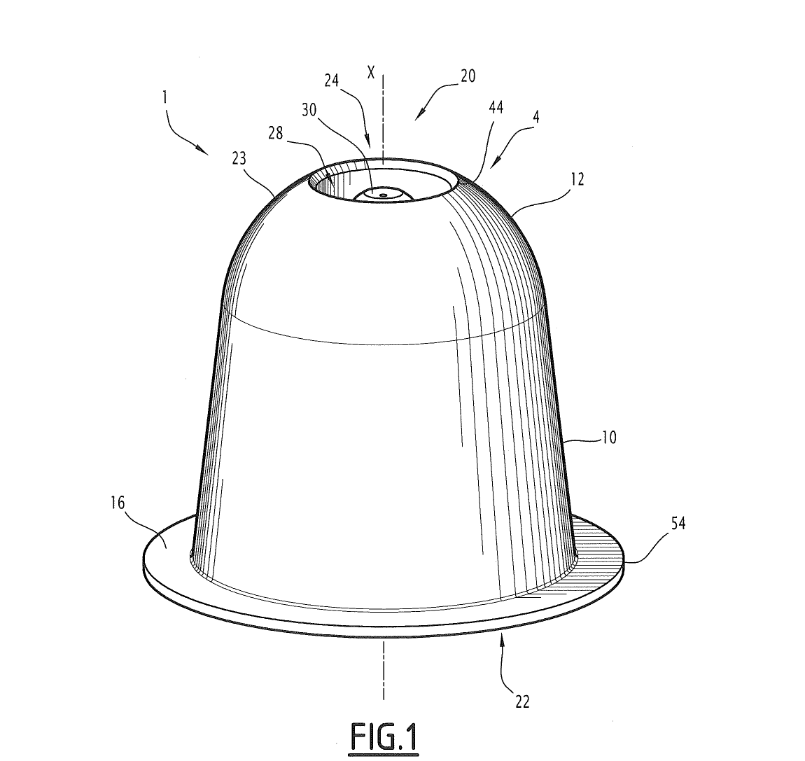

FIG. 1 is a perspective view of a first alternative of a capsule according to a first embodiment of the invention;

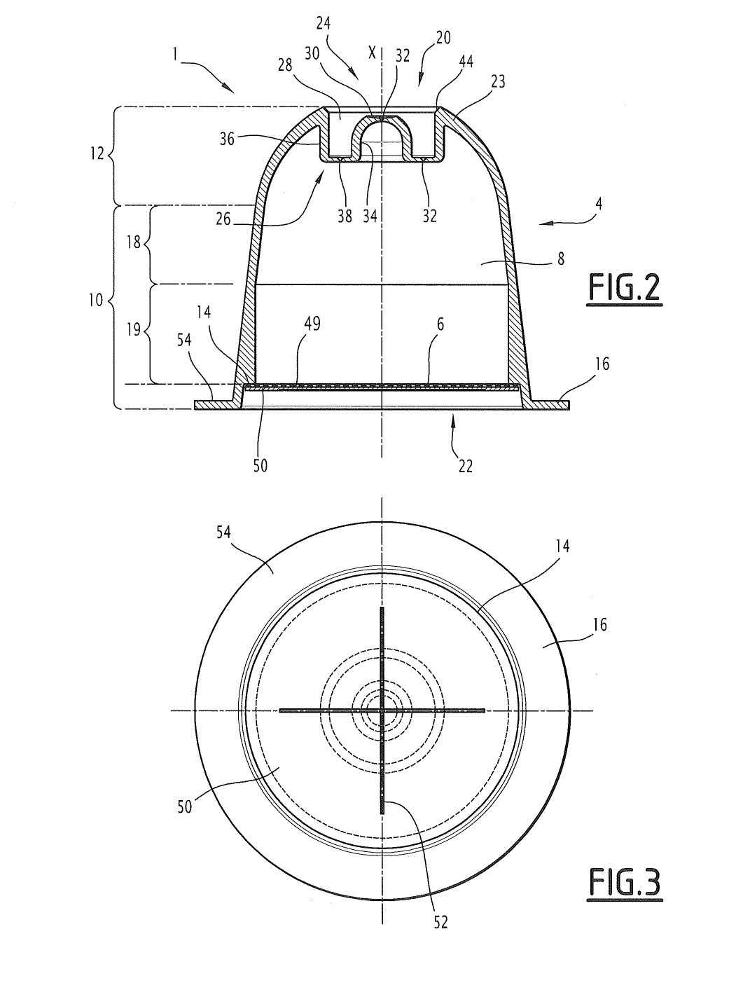

FIG. 2 is a longitudinal cross-sectional view of the capsule of FIG. 1;

FIG. 3 is a front view of the capsule of FIG. 1;

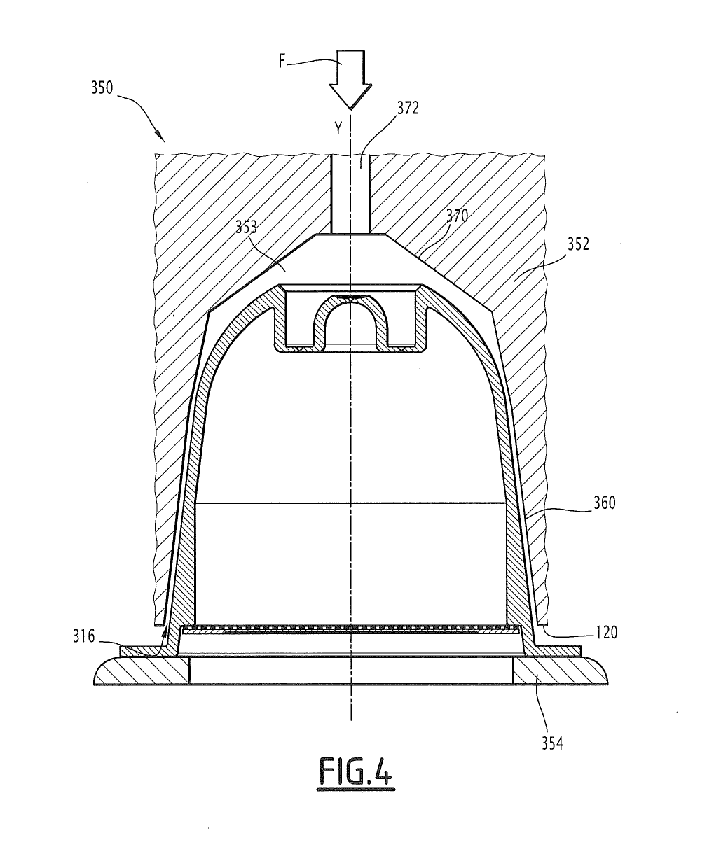

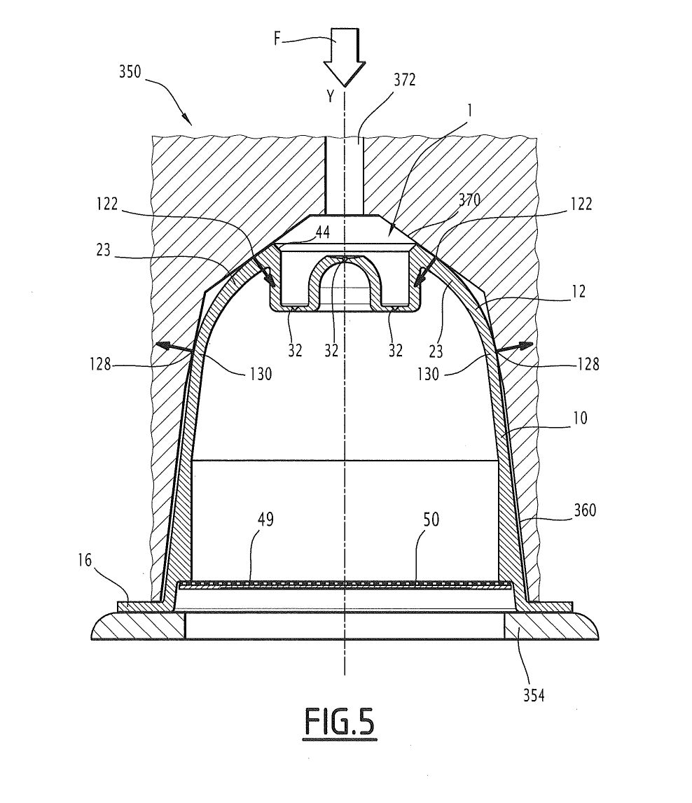

FIGS. 4 and 5 are views of the capsule of FIG. 1, installed in an extraction device in the partially open and closed configurations, respectively;

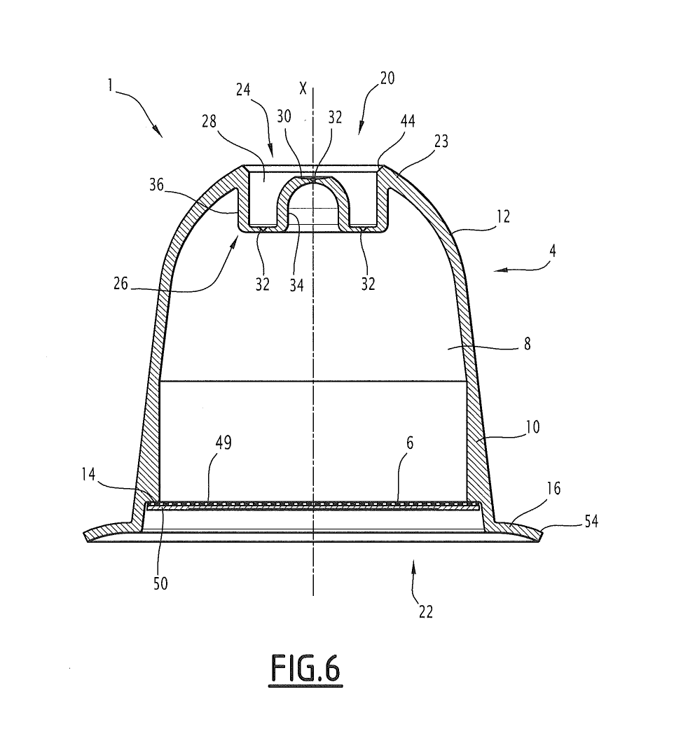

FIG. 6 is a longitudinal cross-sectional view of a second alternative of the capsule according to the first embodiment;

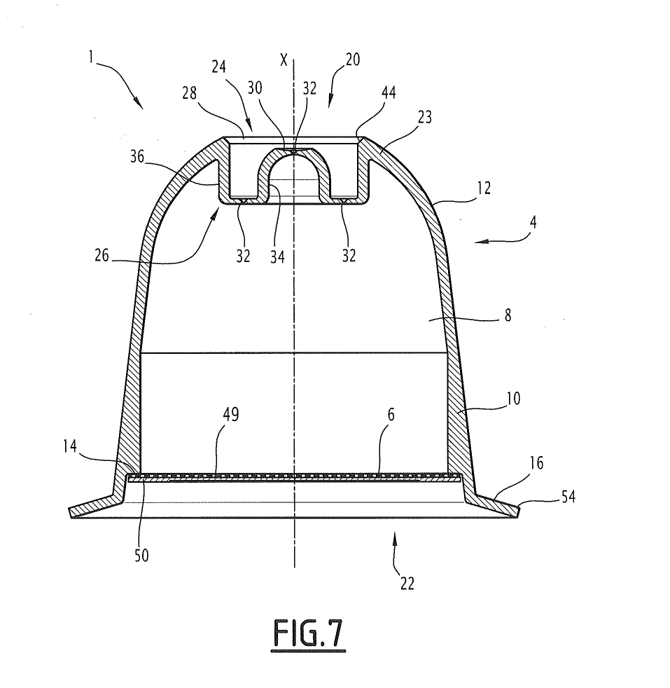

FIG. 7 is a longitudinal cross-sectional view of a third alternative of the capsule according to the first embodiment;

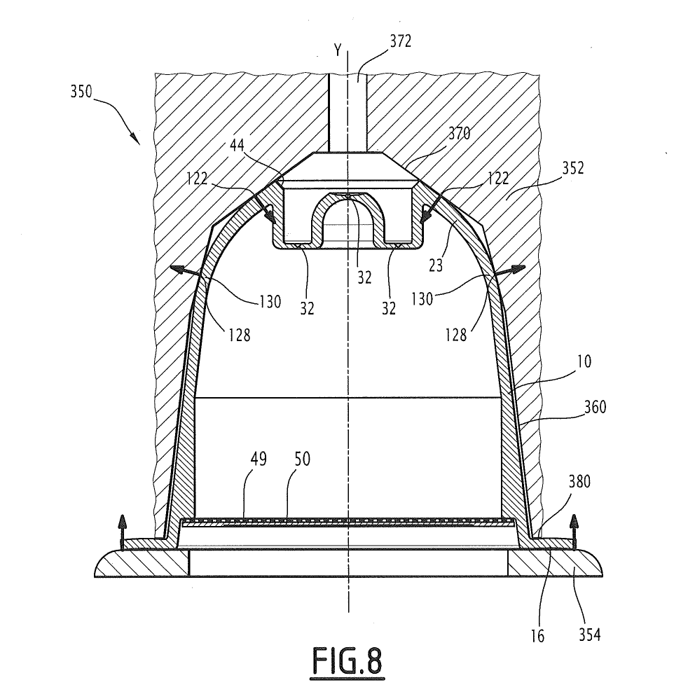

FIG. 8 is a view of the capsule of FIG. 6, installed in an extraction device in the closed configuration;

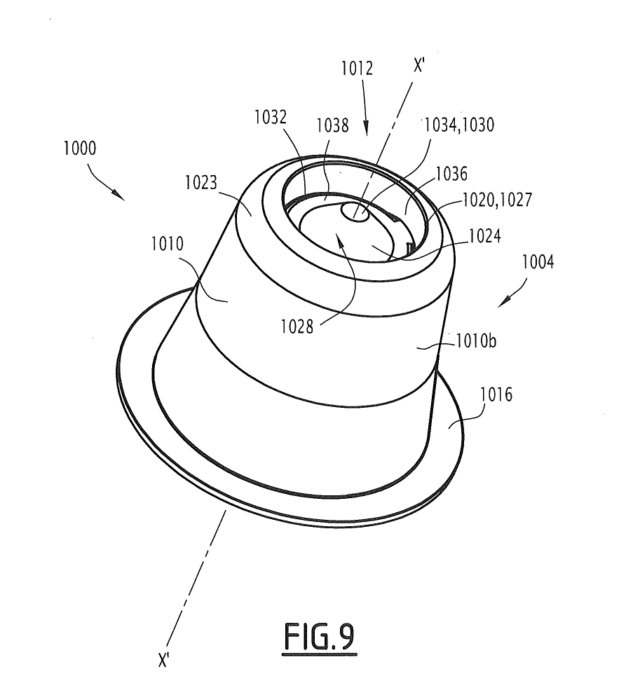

FIG. 9 is a perspective view of a first alternative of a capsule according to a second embodiment of the invention;

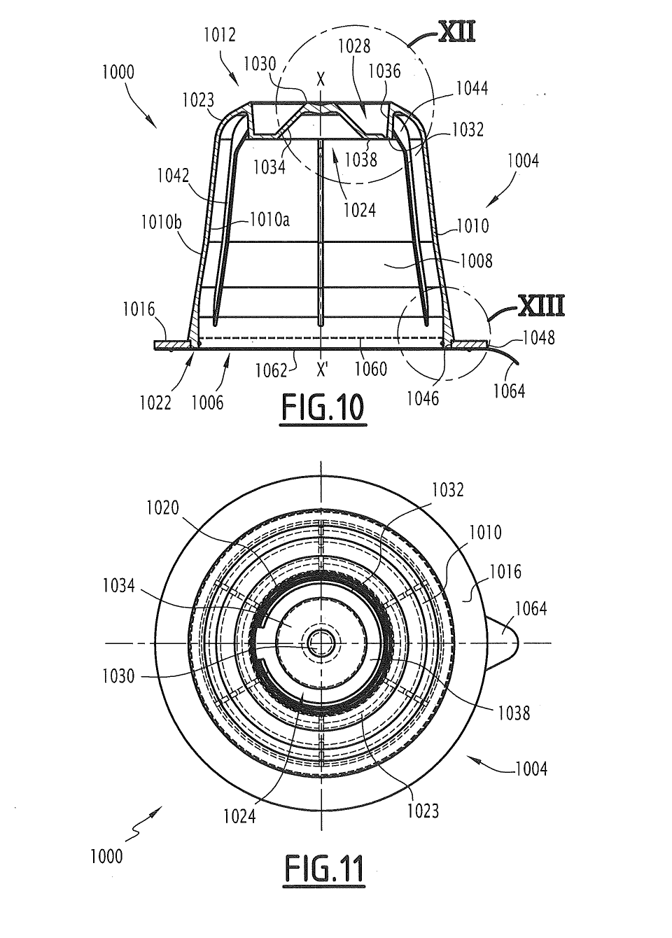

FIG. 10 is a longitudinal cross-sectional view of the capsule of FIG. 9;

FIG. 11 is a rear view of the capsule of FIG. 9;

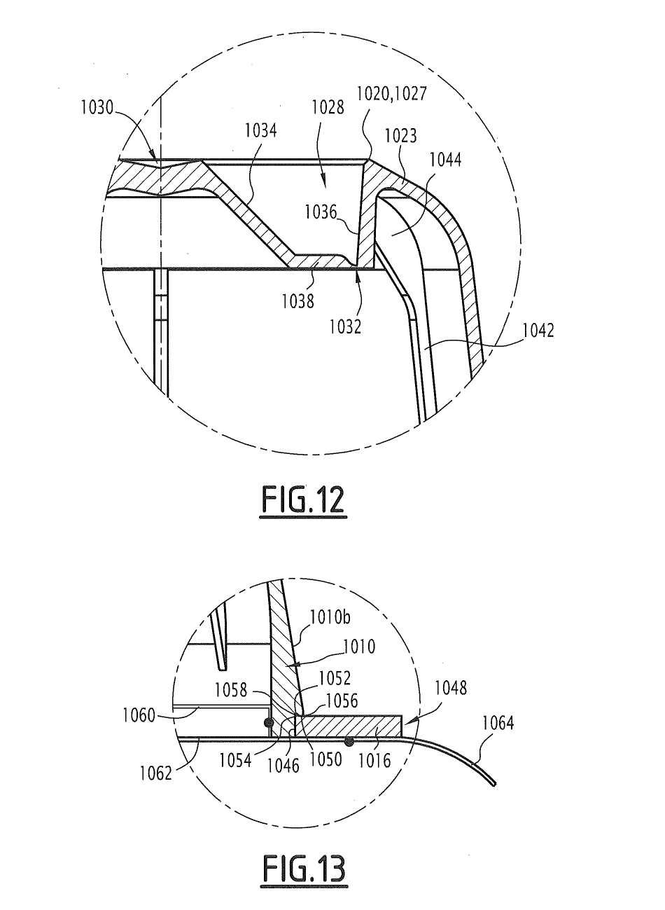

FIG. 12 is a view of a detail marked XII in FIG. 10;

FIG. 13 is a view of a detail marked XIII in FIG. 10;

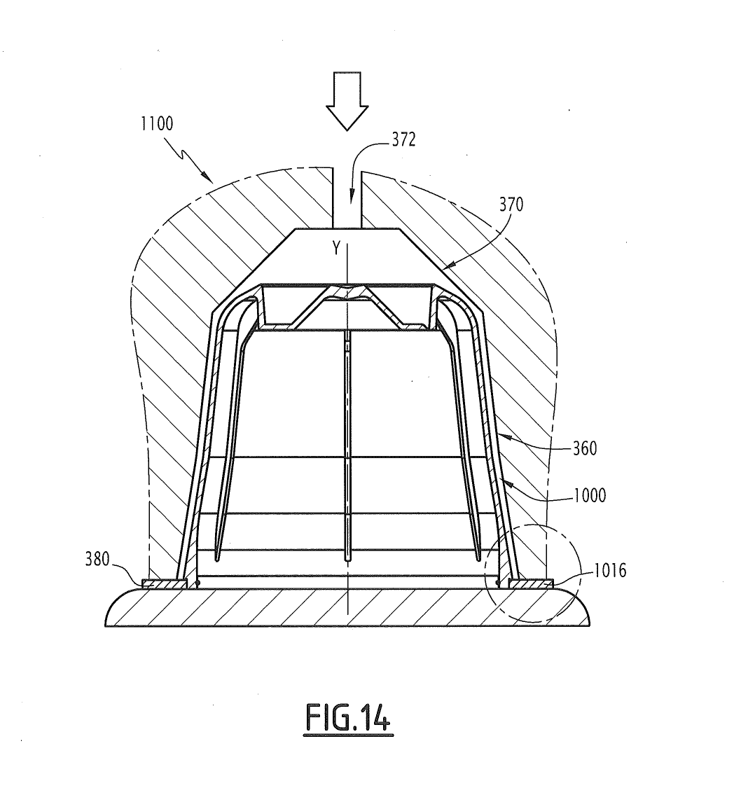

FIG. 14 is a view of the capsule of FIG. 8, installed in a first extraction device in the closed configuration;

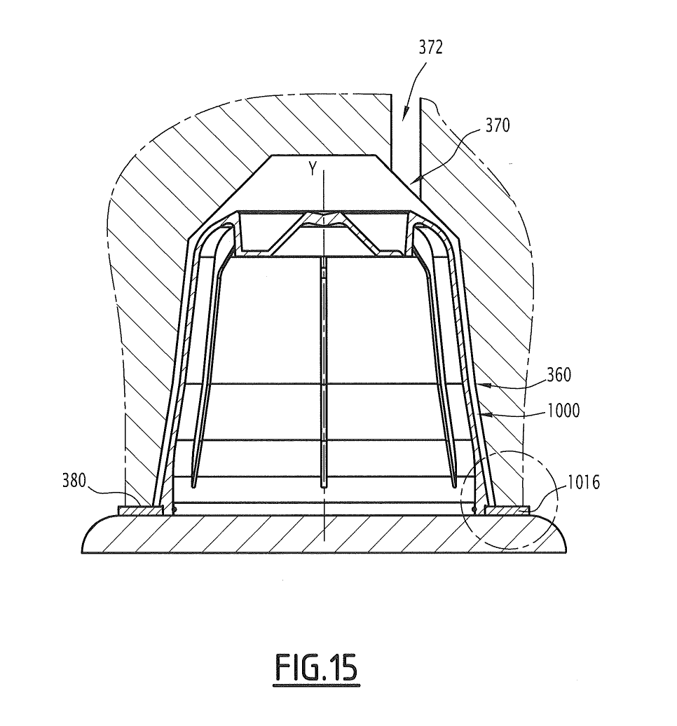

FIG. 15 is a view similar to FIG. 14, the capsule being installed in a second extraction device in the closed configuration;

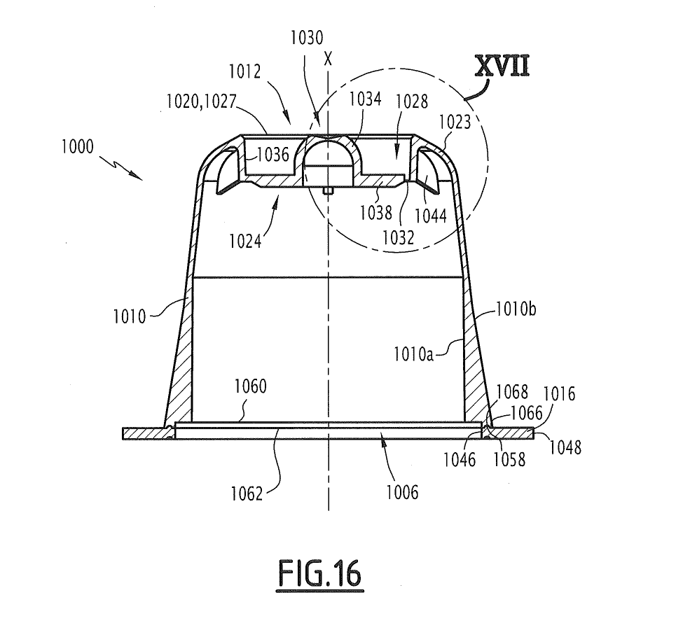

FIG. 16 is a longitudinal cross-sectional view of a second alternative of a capsule according to the second embodiment;

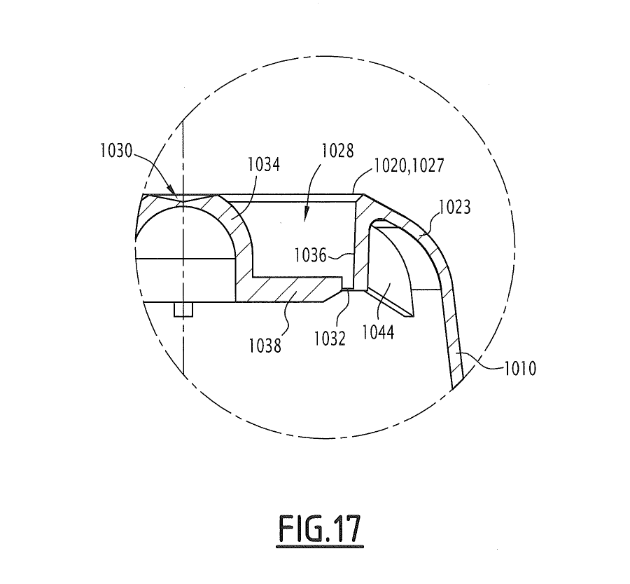

FIG. 17 is a view of a detail marked XVII in FIG. 16;

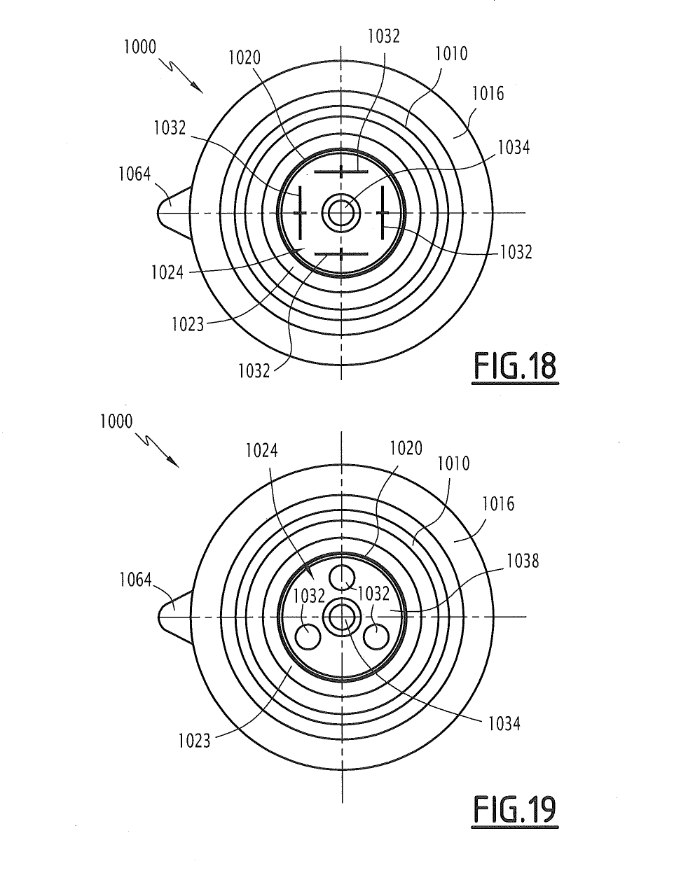

FIG. 18 is a rear view of a third alternative of a capsule according to the second embodiment;

FIG. 19 is a rear view of a fourth alternative of a capsule according to the second embodiment;

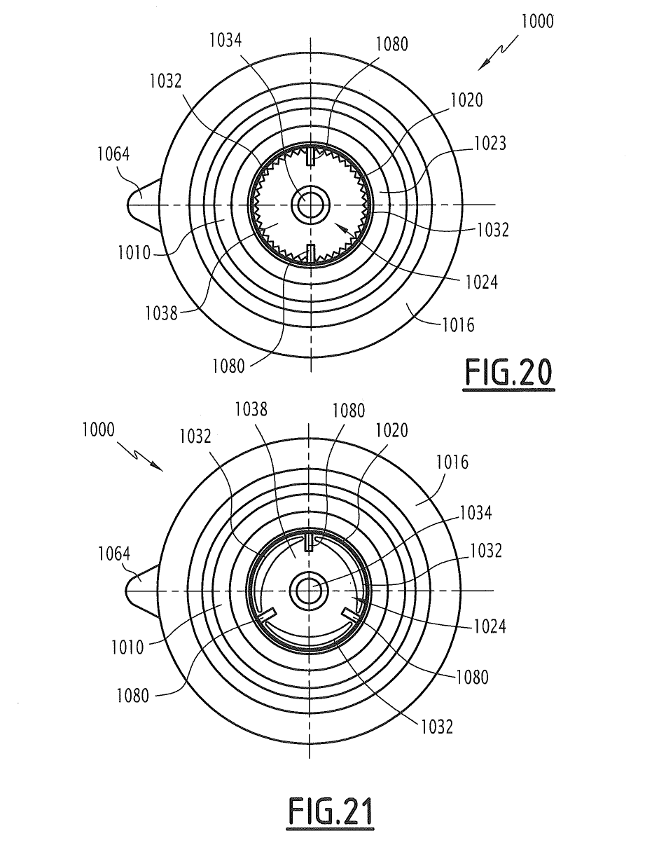

FIG. 20 is a rear view of a fifth alternative of the capsule according to the second embodiment;

FIG. 21 is a rear view of a sixth alternative of a capsule according to the second embodiment;

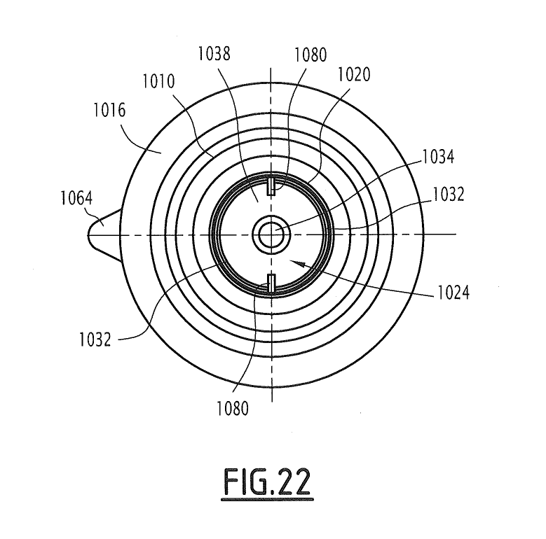

FIG. 22 is a rear view of a seventh alternative of a capsule according to the second embodiment;

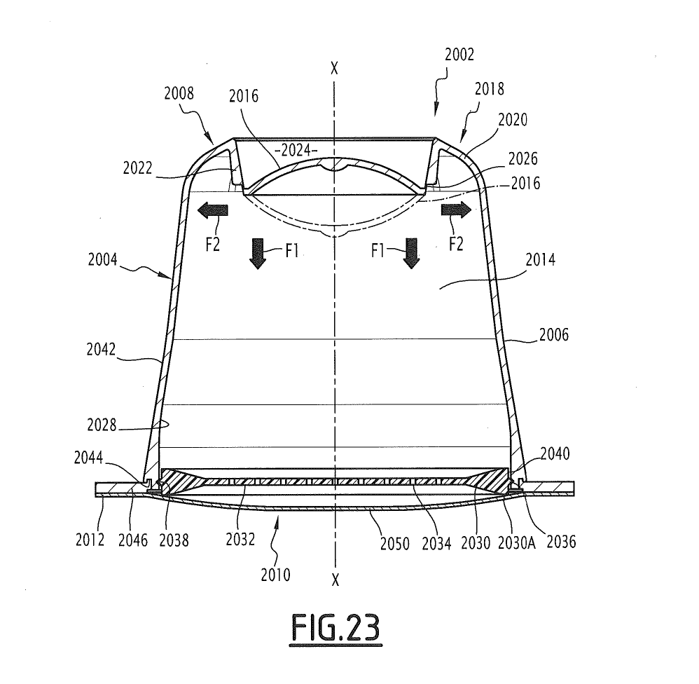

FIG. 23 shows a cross-sectional view of a capsule according to a third embodiment;

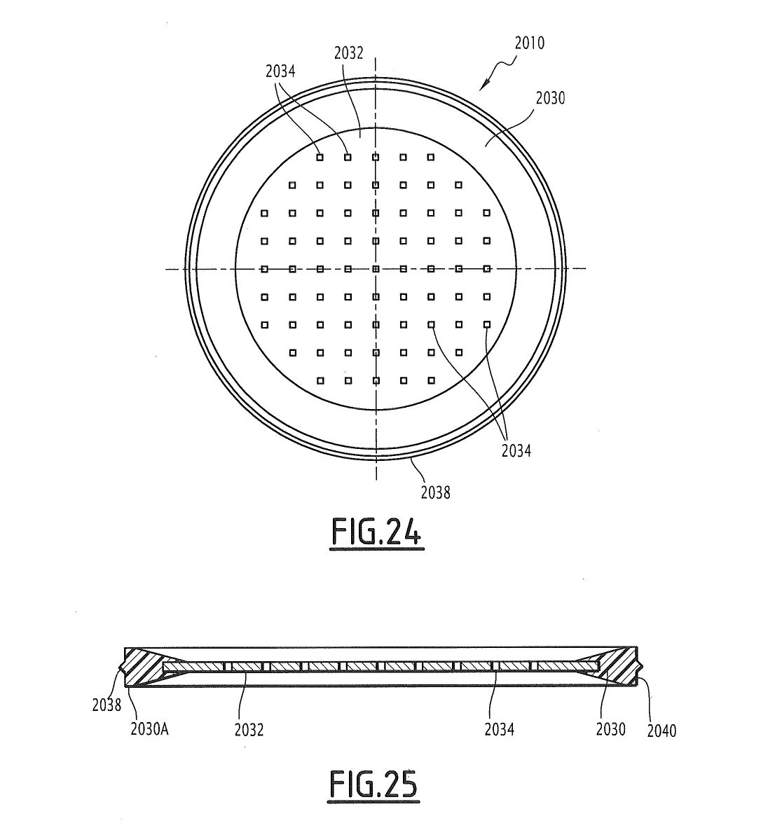

FIG. 24 is a front view of an outlet wall of the capsule of FIG. 23;

FIG. 25 is a cross-sectional view of an outlet wall according to one alternative of a capsule according to the third embodiment;

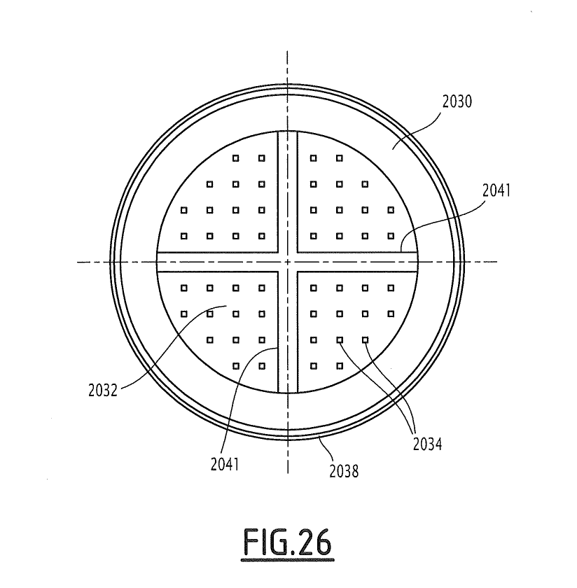

FIG. 26 is a front view of an outlet wall according to another alternative of a capsule according to the third embodiment; and

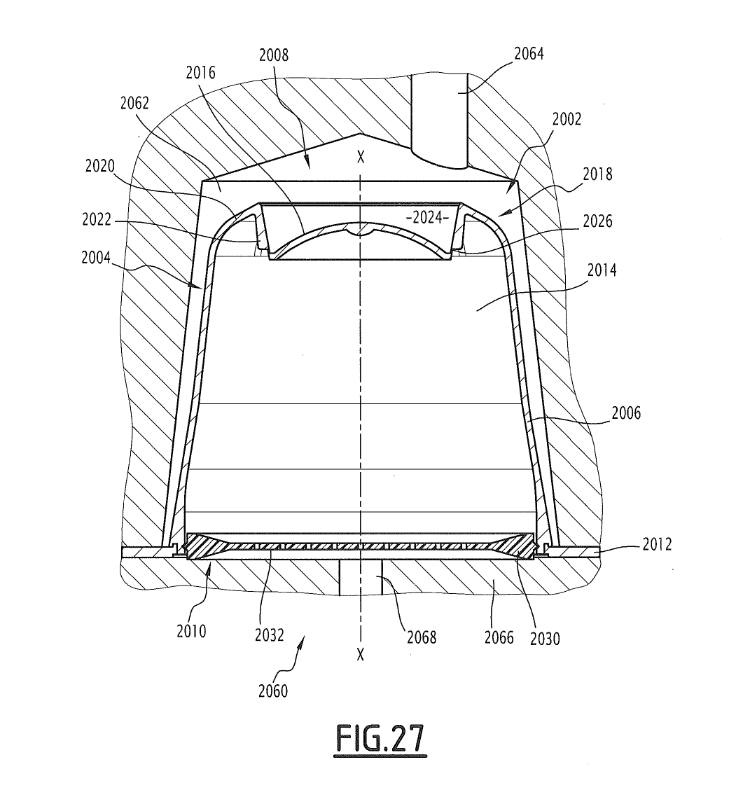

FIG. 27 is a cross-sectional view of an extraction device into which the capsule of FIG. 23 is inserted.

The capsule 1 according to a first embodiment of the invention, shown in FIGS. 1 and 3, includes a hollow body 4 and an outlet cap 6 together delimiting an inner chamber 8 containing a substance (not shown) for preparing a drink.

The body 4 also is generally in the shape of a cup and comprises a side wall 10, a bottom 12 closing a closed rear end 20 of the body 4, and an annular rim 16 surrounding an open front end 22 of the body 4.

The body 4 is made in a single piece. The side wall 10, the bottom 12 and the annular rim 16 are integral. The body 4 is made from an airtight and watertight material, for example a plastic or plastic derivative material, or metal.

The side wall 10 extends from the bottom 12 along a longitudinal axis X as far as the front end 22 of the body 4.

The side wall 10 comprises an inner shoulder 14. The shoulder 14 extends in a radial plane and is oriented toward the front.

The side wall 10 is substantially tapered of revolution around the longitudinal axis X. The side wall 10 comprises a rear segment 18, which is relatively flexible, extending from the bottom 12, and a front segment 19, which is relatively rigid, axially extending the rear segment 18. The front segment 19 has an axially increasing thickness, greater than that of the rear segment 18.

The bottom 12 has a peripheral region 23, extending radially toward the inside from the side wall 10, and a central region 24.

The peripheral region 23 is rounded. It extends radially inward and axially backward from the side wall 10, and has a concave side turned toward the inside of the body 4.

The central region 24 comprises an annular rib 26 protruding axially toward the inside of the body 4 from the peripheral region 23. The annular rib 26 defines an annular trench 28 open toward the outside of the body 4 toward the rear. The annular rib 26 defines a hollow central stud 30 protruding axially from the bottom of the annular trench 28 while defining a recess inside the body 4.

The central region 24 has at least one area of least resistance 32 provided to break under the effect of a pressurized fluid. The areas of least resistance 32 are for example provided in the form of thinner areas of the central region 24, for example defined by indentations formed in the central region 24.

The areas of least resistance 32 are provided in walls of the annular rib 26 and/or on the central stud 30.

In the illustrated example, the annular rib 26 comprises a tubular outer portion 36 extending axially toward the inside from the peripheral region 23, a tubular inner portion 34 delimiting a side face of the central stud 30, and a bottom portion 38 extending radially between the upper portion 36 and the inner portion 34 while giving the annular rib 26 a substantially U-shaped transverse cross-section.

As shown in FIG. 2, areas of least resistance 32 are provided in the bottom portion 38 and in the central stud 30 in the form of thinner areas.

Alternatively, the central region 24 has no area of least resistance 32 in the central stud 30. Alternatively or optionally, the annular rib 26 has areas of least resistance 32 in the outer portion 36 and/or the inner portion 34.

In another possible alternative that differs from that of FIG. 2 through the shape of the annular rib 26, the outer portion 36 and the inner portion 34 converge while giving the annular rib 26 a substantially V-shaped transverse cross-section. In that case, areas of least resistance 32 can be provided in the outer portion 36, the inner portion 34 and/or the central stud 30.

As shown in FIG. 2, the annular trench 28 has an annular outer edge 44, preferably beveled, at the junction between the annular rib 26 and the peripheral region 23. The outer edge 44 delimits the rear end 20 of the capsule 1. The central stud 30 is axially set back toward the inside of the body 4 relative to the outer edge 44.

Preferably, the peripheral region 23 has an excess thickness along the outer edge 44, so as to strengthen the outer edge 44. The peripheral region 23 for example has a thickness increasing from the side wall 10 toward the outer edge 44.

The inner shoulder 14 is annular and protrudes radially from the side wall 10 toward the inside of the body 4. It is axially set back toward the inside of the body 4 relative to the front end 22 of the body 4 and the annular rim 16.

The cap 6 is fastened by its periphery on the inner shoulder 14 such that the cap 6 is positioned axially set back toward the inside of the body 4 relative to the front end 22 of the body 4. Preferably, the withdrawal distance of the cap 6 relative to the front end 22 of the body 4 is greater than 1 mm.

The cap 6 closes the front end 22 of the body 4.

The cap 6 comprises an outlet filter 49 capable of allowing a pressurized fluid to pass while retaining the substance contained in the chamber 8. The filter 49 is made from porous filter paper, woven plastic material, or perforated plastic film.

The cap 6 further comprises an airtight and watertight membrane 50 lining the filter 49. The membrane 50 has weakening lines 52, such that the membrane 50 can tear under only the effect of the pressure of the liquid. In the example illustrated in FIGS. 1 and 3, the weakening lines 52 form an X. Alternatively, they form a circle, arcs of circle, or any other shape suitable to allow optimal tearing of the membrane 50.

The filter 49 is positioned between the chamber 8 and the membrane 50. The filter 49 and the membrane 50 are alongside one another. The filter 49 and the membrane 50 for example assume the form of a complex dual layer film.

The annular rim 16 extends radially outward from the side wall 10. The annular rim 16 defines the front end 22 of the body 4. The rim 16 has a free marginal region 54. It does not support any attached sealing element or deformable raised sealing element. As shown in FIGS. 1 and 3, the annular rim 16 is substantially planar.

The capsule 1 is designed to be positioned in an extraction device 350, shown in FIGS. 4 and 5.

The extraction device 350 includes a hollow receiving element 352, delimiting a housing 353 for receiving the capsule 1, and a support 354. It can be maneuvered between an open configuration, in which the receiving element 352 and the support 354 are separated from each other to insert the capsule 1 into the receiving element 352, and a closed position, shown in FIG. 5, in which the receiving element 352 and the support 354 are close together, to inject the extraction liquid into the capsule 1. In FIG. 4, the device 350 is shown in an intermediate configuration in which it is partially open, but not, however, open enough to allow the capsule 1 to be inserted.

The housing 353 has an inner side face 360, a housing bottom 370 and an extraction liquid intake line 372 emerging on the bottom of the housing 370, substantially at the center and an opening 376 for inserting the capsule 1.

The inner side face 360 is of revolution around the longitudinal axis Y. In the illustrated example, it is substantially tapered. When the capsule 1 is placed in the extraction device 350, the longitudinal axes X of the capsule 1 and Y of the housing 353 are substantially combined.

The receiving element 352 has an annular edge 380 surrounding the opening 376.

The capsule 1 has a sufficient axial length so that, in the closed configuration of the extraction device 350, the capsule 1 bears by its annular rim 16 against the support 354 and by its bottom 12 against the housing bottom 370 along a closed annular contact line 122, preferably defined over the peripheral region 23 along the outer edge 44 of the annular trench 28.

The capsule 1 is advantageously suitable for elastically deforming under the effect of an axial compression force F to provide sufficient contact between the bottom 12 and the housing bottom 370.

Optionally, the capsule 1 is suitable so that, under the effect of the axial compression force F, at least one annular zone 130 of the bottom 12 and/or the side wall 10 of the capsule 1 expands radially outward so as to ensure additional contact 128 with the side face 360 of the housing 353, along a closed annular contact line.

The method for extracting the capsule 1 using the extraction device 350 will now be described.

The capsule 1 is first placed in the device 350 in the open configuration, then the device 350 is maneuvered to move into the closed configuration.

During this movement toward the closed configuration, the capsule 1 bears by its annular rim 16 against the support 354, then the receiving element 352 bears axially on the bottom 12 of the capsule 1, such that the contact 122 is created, and the body 4 deforms in its entirety such that the contact 128 is created with the receiving element 352 of the device 350.

Once the device 350 is in the closed configuration, the extraction fluid is injected under pressure through the line 372. Under the effect of the pressure of the extraction fluid, the areas of least resistance 32 of the central region 24 of the bottom 12 break and the extraction fluid penetrates the capsule 1.

The liquid pressure in the capsule 1 then increases and, under the effect of that pressure, the outlet membrane 50 tears. The fluid then escapes outside the capsule 1 by passing through the cap 6 while being filtered by the filter 49.

Owing to the invention, the bottom reinforced by an annular rib makes it possible to make the body of the capsule from a relatively flexible, deformable material, without the bottom collapsing toward the inside of the capsule under the effect of the fluid pressure. The convexity of the bottom makes it possible to define a strong and elastically deformable bottom, with a large volume of the chamber making it possible to load a larger quantity of substance into the capsule. The rib delimiting an annular trench in the outer face makes it possible to improve the injection of the extraction liquid in the capsule. The presence of an annular rim makes it possible to increase the stability of the capsule on the support of the extraction device.

The capsule has a cup-shaped body whereof the bottom is airtight and watertight, the body being closed by an airtight and watertight cap. The tightness of the capsule makes it possible to keep the substance sheltered from air and moisture. The cap has a membrane tearing under the effect of the pressurized fluid allowing suitable opening of the cap from a predetermined pressure level, with a delay effect that is beneficial for quality extraction. The cap axially set back toward the inside of the body prevents any interference with the support of the extraction device before opening of the membrane, and thereby allows controlled opening of the capsule. The membrane associated with a filter makes it possible to ensure extraction of the substance under satisfactory pressure conditions with effective retention of the substance inside the capsule. The cap provided in the form of a complex film facilitates manufacturing of the capsule at a low cost.

The capsule alternatives illustrated in FIGS. 6 and 7 differ from that of FIGS. 1 to 3 in that the marginal region 54 of the annular rim 16 is inclined toward the front of the capsule 1. As shown in FIG. 6, the annular rim 16 is curved toward the front of the capsule 1. As shown in FIG. 7, the annular rim 16 is tapered flaring toward the front.

As illustrated in FIGS. 8 and 9, during closing of the extraction device 350, under the force of the bearing force exerted by the support 354, the annular rim 16 deforms by flattening.

Such a rim 16 makes it possible to guarantee and strengthen the contact 122 between the bottom 12 of the capsule 1 and the housing bottom 370 upon closing of the device 350, while being able to deform to allow the extraction device 350 to close.

The capsule 1000 according to a second embodiment of the invention, shown in FIGS. 9 to 21, comprises, as shown in FIGS. 9 and 10, a hollow body 1004 and an outlet cap 1006 together delimiting an inner chamber 1008 containing a substance (not shown) for preparing a drink.

The body 1004 is generally cup-shaped and is airtight and watertight. It comprises an outer side wall 1010, a bottom 1012 closing a rear end 1020 of the body 1004, and an annular rim 1016 surrounding an open front end 1022 of the body 1004.

The outer side wall 1010 and the bottom 1012 are integral and made from a first airtight and watertight plastic material. The first plastic material is chosen to be inert with respect to the substance contained in the capsule 1000. Preferably, the mass of said first material is translucent and not colored, so as to avoid diffusing color into the substance. Typically, the second plastic material is polyamide. The polyamide does not interfere with the food products and constitutes a very high-performing barrier against air and water.

Preferably, the annular rim 1016 is made from a second plastic material, different from the first plastic material. The second plastic material is chosen to be a low-cost material. This material not being in contact with the substance, its properties with respect to the substance are not taken into account in choosing the second material. Typically, the second plastic material is polyurethane, which is an inexpensive material.

Preferably, the first and second plastic materials are compatible materials, i.e., materials suitable for polymerizing with each other.

Thus, it is possible to produce capsules 1000 at a lower cost. These capsules being designed to be produced in very large series, this makes it possible to achieve significant savings.

Preferably, the mass of the second material is colored. Thus, it is possible to color the annular rims 1016 of capsules 1000 containing different substances differently, so as to distinguish easily between a capsule 1000 containing a first substance and another capsule 1000 containing a second substance, different from the first.

The outer side wall 1010 extends from the bottom 1012 along a longitudinal axis X as far as the front end 1022 of the body 1004.

The outer side wall 1010 is substantially tapered of revolution around the longitudinal axis X. It is rigid. It has an inner surface 1010a, oriented toward the chamber 1008, and an outer surface 1010b, opposite the inner surface 1010a.

The bottom 1012 comprises a peripheral region 1023 and a central region 1024.

The peripheral region 1023 is rigid. It is rounded and extends radially toward the inside and axially toward the rear from the outer side wall 1010, and has a concave side turned toward the inside of the body 1004. It thus extends from the outer side wall 1010 as far as the rear end 1020 of the body 1004. The rear end 1020 is typically a closed line, for example a circle.

The central region 1024 axially draws in toward the inside of the chamber 1008 from the peripheral region. The central region 1024 thus defines, in the bottom 1012, a recess 1028 outside the body 1004.

The central region 1024 comprises a tubular outer portion 1036 extending axially toward the inside of the chamber 1008 from the peripheral region 1023, a bottom portion 1038 extending radially toward the inside from the inner end of the outer portion 1036 and closing the recess 1028, and a central inner portion 1034 protruding toward the outside from the bottom portion 1038.

The inner portion 1034 defines a hollow central stud 1030 in the recess 1028. The latter thus has an annular shape. The outer portion 1036, the bottom portion 1038 and the inner portion 1034 define an annular rib 1026 in the central region 1024.

The bottom portion 1038 comprises at least one area of least resistance 1032 provided to break under the effect of a pressurized fluid. Preferably, the or each area of least resistance is provided to break at a pressure of the pressurized fluid comprised between 1 and 3 bars.

The or each area of least resistance 1032 is for example provided in the form of thinner areas, as shown in FIG. 12. As long as the or each area of least resistance 1032 is not broken, the bottom 1012, and by extension the entire body 1004, is impermeable to air and liquids.

In the example shown in FIG. 11, the area of least resistance is defined at the periphery of the bottom portion 1038, at the junction between the bottom portion 1038 and the outer portion 1036. The area of least resistance assumes the form of an arc of circle. The arc of circle preferably extends over at least 270°.

The shape of the inner portion 1034 conditions the axial shearing force generated by a pressurized liquid present in the recess 1028.

In the embodiment of FIGS. 9 to 15, the inner portion 1034 has a tapered shape, widening from the back toward the front of the 1000, and protruding toward the outside.

Alternatively, the inner portion 1034 extends in a radial plane. At a predetermined pressure of the fluid present in the recess 1028, a planar inner portion 1034 causes a higher shearing force than an inner portion protruding toward the outside.

The body 1004 also comprises longitudinal stiffening ribs 1042 for the outer side wall 1010 and radial stiffening ribs 1044 for the bottom 1012.

Each longitudinal rib 1042 extends longitudinally along the outer side wall 1010, preferably, as shown, along the inner surface 1010a. Thus, the longitudinal ribs are suitable for favoring the emulsion between the pressurized fluid and the substance contained in the chamber 1008. Alternatively, each longitudinal rib 1042 extends along the outer surface 1010b.

Each radial rib 1044 extends radially between the outer portion 1036 and the peripheral region 1023. The radial ribs 1044 stiffen the bottom 12 and thereby favor the generation of shearing forces caused by the pressure of the pressurized fluid directly on the or each weakening area 1032. In the example illustrated in FIGS. 10 to 15, each radial rib 1044 extends in the extension of a longitudinal rib 1042.

The annular rim 1016 extends radially toward the outside, from an inner annular border 1046 to an outer annular border 1048, from the outer surface 1010b of the outer side wall 1010. It defines the front end 1022 of the body 1004. It does not support any attached sealing element or deformable raised sealing element. Preferably, it is substantially planar. The outer annular border 1048 is free.

As shown in the detail illustrated in FIG. 13, the outer surface 1010b of the outer side wall 1010 defines, near the front end 1022 of the body 1004, an annular notch 1049 defining a shoulder 1050 and a groove 1052 for connecting the annular rim 1016 to the outer side wall 1010.

The shoulder 1050 is set back toward the rear relative to the front end 1022. It extends radially and parallel to the front end 1022, between an inner end 1054 and an outer end 1056.

The groove 1052 is formed in the shoulder 1050 and protrudes longitudinally backward from the inner end 1054 of the shoulder 1050.

The annular rim 1016 comprises an annular protuberance 1058 protruding longitudinally from the inner annular border 1046 in the groove 1052. The protuberance 1058 cooperates with the groove 1052 to strengthen the connection of the annular rim 1016 to the outer side wall 1010.

Thus, part of the outer side wall 1010 extends between the annular rim 1016 and the chamber 1008, which prevents the substance from being in contact with the second material.

Returning to FIG. 1, the cap 1006 is fastened by its periphery on the outer side wall 1010 and on the annular rim 1016. The cap 1006 thereby closes the front end 1022 of the body 1004.

The cap 1006 comprises an outlet filter 1060 capable of allowing a pressurized fluid to pass while retaining the substance contained in the chamber 1008. The filter 1060 is made from a porous filter paper, a woven plastic material or a perforated plastic film. Preferably, the filter 1060 is, as shown, set back from the front end 1022, toward the chamber 1008, and is fastened on its periphery to the inner surface 1010a of the outer side wall 1010. The filter 1060 is for example positioned between 1 and 1.5 mm set back relative to the front end 1022.

The cap 1006 further comprises an airtight and watertight membrane 1062 lining the filter 1060. Preferably, the membrane 1062 is fastened, for example welded, on the annular rim 1016. The membrane 1062 extends along the front end 1022 of the body 1004. The membrane 1062 makes it possible to keep the substance in an inert atmosphere, so as to avoid any oxidation of the substance.

The membrane 1062 is strippable, i.e., it can easily be separated from the body 1004. To that end, it comprises a tongue 1064 extending radially toward the outside from the annular rim 1016, to allow a user to remove the membrane 1062 easily before using the capsule 1000 in an extraction device.

Optionally, the membrane 1062 has weakening lines (not shown), such that the membrane 1062 can tear under the sole effect of the pressure of a liquid. Thus, in the event a user has forgotten to remove the membrane 1062 before inserting the capsule 1000 in an extraction device, the extraction device can still be run normally, without any risk of damage to the extraction device.

The filter 1060 is positioned between the chamber 1008 and the membrane 1062. The space between the filter 1060 and the membrane 1062 is preferably filled with an inert gas, typically with nitrogen.

The capsule 1000 is shown in FIG. 14 inserted into a drink extraction device 1100. This device 1100 is similar to the extraction device 350 described above. The similar elements are designated using the same reference signs. It will be noted that the capsule 1000 is suitable for the annular edge 380 to come into contact with the annular rim 1016 when the extraction device 1100 is in the closed configuration.

One alternative of the extraction device 1100 is shown in FIG. 15. In that Figure, it is possible to see that the extraction liquid intake line 372 is radially offset relative to the longitudinal axis Y. Thus, the capsule 1000 is also suitable for being used in drink extraction devices where the arrival of pressurized liquid in the receiving housing 353 is not done at the center of the housing 353.

One alternative of the capsule 1000 is shown in FIGS. 16 and 17.

In this alternative, the inner portion 1034 has a hemispherical shape whereof the concave side is turned toward the inside of the body 1004. This shape is suitable for allowing the rupture of the weak area 1032 at higher pressures in the event the inner portion 1034 has a tapered shape.

The annular rim 1016 is not connected to the outer surface 1010b of the outer side wall 1010, but to a front annular face 1066 of the outer side wall 1010. Said front annular face 1066 defines a groove 1068 protruding longitudinally backward and with which the protuberance 1058 of the annular rim 1016 cooperates to reinforce the connection of the annular rim 1016 with the outer side wall 1010.

The inner surface 1010a of the outer side wall 1010 defines an annular inner shoulder 1070 extending in a radial plane and oriented toward the front. The inner shoulder 1070 is axially set back toward the inside of the body 1004 relative to the front end 1022 of the body 1004 and the annular rim 1016. This inner shoulder 1070 is suitable for bearing the cap 1006.

The inner shoulder 1070 being set back relative to the front annular face 1066, the substance is thus not in contact with the second material forming the annular rim 1016.

As in the first embodiment, the cap 1006 is formed by a complex dual layer film comprising the filter 1060 and the membrane 1062. This complex film is fastened by its periphery on the inner shoulder 1070 such that the cap 1006 is positioned axially set back toward the inside of the body 1004 relative to the front end 1022 of the body 1004. Preferably, the withdrawal distance of the cap 1006 relative to the front end 1022 of the body 1004 is greater than 1 mm.

Other alternatives of the capsule 1000 are shown in FIGS. 18 to 22.

In the alternative shown in FIG. 18, the bottom portion 1038 comprises multiple areas of least resistance 1032, each being formed by two weakening lines intersecting to form an X. In the illustrated example, there are four areas of least resistance 1032. Alternatively, the number of areas of least resistance 1032 is different.

In the alternative shown in FIG. 18, the bottom portion 1038 comprises multiple areas of least resistance 1032, each being formed by a closed circular weakening line, each delimiting a disc not including the inner portion 1034. In the illustrated example, there are three areas of least resistance 1032. Alternatively, the number of areas of least resistance 1032 is different.

In the alternative shown in FIG. 20, the bottom portion 1038 comprises two areas of least resistance 1032, each in the shape of a jagged half-circle and extending to the periphery of the bottom portion 1038, along the junction with the outer portion 1036.

The bottom 12 further comprises two reinforcing ribs 1080 for the central region 1024. Each rib 1080 extends longitudinally between the tubular portion 1026 and the peripheral border 1030. Each rib 1080 is inserted between the two areas of least resistance 1034. In the illustrated example, the ribs 1080 are thus diametrically opposite one another.

These ribs 1080 are intended to concentrate the shearing forces due to the force exerted by the pressurized fluid on the bottom 1012 in the extraction device 1100 on the areas of least resistance 1034.

In the alternative shown in FIG. 21, the bottom portion 1038 comprises three areas of least resistance 1032, each being formed by a closed line delimiting a crescent whereof the large side extends along the outer portion 1036.

The bottom 1012 also comprises reinforcing ribs 1080 for the central region 1024. There are three of these ribs 1080 here, and each is inserted between two areas of least resistance 1032.

Lastly, in the alternative shown in FIG. 22, the bottom portion 1038 comprises a single area of least resistance 1032 formed by a closed circular line extending along the outer portion 1036.

The method for manufacturing the capsule 1000 will be briefly described in light of FIG. 10.

First, the first plastic material is poured, for example injected, in a mold, to form the bottom 1012 and the outer side wall 1010. Then, secondly, the second plastic material is poured in the mold in turn, so as to form the annular rim 1016.

The first and second plastic materials being compatible materials, they bond chemically. In particular, part of the molecules of the first material diffuse in the second material and vice versa. Thus, a fine layer forms in which the two materials are mixed, and the two materials are thus closely bonded to each other.

Owing to the invention, the part of the body of the capsule in contact with the substance is made from a material that is inert with respect to the substance, which makes it possible to keep the substance under optimal conditions, without any risk of degradation of the substance due to oxidation or toxic elements contained in the material in contact with the substance.

Furthermore, the fact that the mass of the first plastic material is not colored makes it possible to decrease the likelihood of migration of toxic elements from the capsule to the substance.

Lastly, using a second material for the annular rim makes it possible to reduce the manufacturing cost of the capsule and further makes it possible, due to the coloring of the second material, to easily identify the substance contained in the chamber of the capsule, without any risk of migration of the pigments in the substance, the latter not being in contact with the second material.

The capsule 2002 illustrated in FIG. 23 can allow the extraction of a pressurized drink. The capsule 2002 can contain a food substance to be extracted under pressure.

The capsule 2002 comprises a side wall 2006 extending along a longitudinal axis X-X, an inlet wall 2008 closing a first rear end of the side wall 2006, and an outlet wall 2010 closing a second front end of the side wall 2006.

The capsule 2002 comprises an annular rib 2012 surrounding the front end of the side wall 2006 and extending radially outward from the side wall 2006.

The side wall 2006, the inlet wall 2008 and the outlet wall 2010 together delimit a chamber 2014 for receiving a food substance for extracting a drink, for example coffee. The substance present in the capsule 2002 is not shown in the drawings for clarity reasons.

The inlet wall 2008 can allow the entry of a pressurized extraction liquid, preferably water, and the outlet wall 2010 can allow the exit of the extraction liquid after passing through the substance contained in the capsule 2002.

The side wall 2006 and the inlet wall 2008 are integral. They define a body 2004 made in a single piece in the shape of a cup. The side wall 2006 and the inlet wall 2008 are for example injection molded from plastic material.

The side wall 2006 is substantially tapered of revolution around the longitudinal axis X-X. The side wall 2006 flares from its rear end toward its front end. The side wall 2006 is rigid.

The inlet wall 2008 is airtight and watertight and is provided to break under the effect of a pressurized fluid outside the capsule 2002.

The inlet wall 2008 comprises a central dome 16 in the shape of a spherical cap. The dome 2016 has a concave side oriented toward the inside of the capsule 2002. The dome extends transversely to the axis X-X. The dome 2016 is deformable toward the inside of the capsule 2002 under the effect of the pressurized fluid outside the capsule 2002.

The inlet wall 2008 comprises an annular peripheral region 2018 surrounding the dome 2016. The dome 2016 is positioned set back toward the inside of the capsule 2002 relative to the rear end of the capsule 2002. The peripheral region 2018 comprises an annular peripheral portion 2020 and an axial portion 2022. The peripheral portion 2020 surrounds the axial portion 2022. The axial portion 2022 is tubular and extends axially along the axis X-X while drawing in toward the inside of the capsule 2002 from an inner edge of the peripheral portion 2020. The axial portion 2022 is tapered converging toward the inside of the capsule 2002. The dome 2016 is fastened to the distal end of the axial portion 2022 situated toward the inside of the capsule 2002, adjacent to the outlet wall 2010.

The axial portion 2022 and the dome 2016 delimit, in the inlet wall 2008, an outer recess 2024 open toward the back and the bottom of which is formed by the dome 2016 and the side surface by the axial portion 2022.

The inlet wall 2008 comprises an area of least resistance 2026 at the periphery of the dome 2016. The area of least resistance 2026 connects the periphery of the dome 2016 to the peripheral region 2018, more specifically to the tubular portion 2020.

The area of least resistance 2026 is tubular and extends axially along the axis X-X. The area of least resistance 2026 assumes the form of the strip whereof the thickness, considered radially to the axis X-X, is smaller than that of the axial portion 2022. The thickness of the area of least resistance 2026 is also smaller than the thickness of the dome 2016. The area of least resistance 2026 axially extends the axial portion 2022 and connects to the periphery of the dome 2016.

When a pressurized fluid is brought onto the inlet wall 2008, the fluid exerts an axial force on the dome 2016. The dome 2016 withstands and transmits the axial force to the area of least resistance 2026, which is tensed axially as illustrated by arrows F1 in FIG. 23. The dome 2016 tends to be axially crushed wall extending radially on its periphery. The dome 2016, by crushing, biases the area of least resistance 2026 radially outward as shown by the arrows F2 in FIG. 23. The area of least resistance 2026 is biased axially in its extension direction and shearing in its thinner direction. As a result, the area of least resistance 2026 breaks easily under controlled pressure.

In one embodiment, the dome 2016 is sudden-acting and can reverse under the effect of the pressure of a fluid on the inlet wall 2008. The dome 2016 reverses abruptly such that its concave side reverses under the effect of the pressurized fluid, as shown in dotted lines in FIG. 23. When a pressurized fluid is brought onto the inlet wall 2008, the fluid exerts a force on the dome 2016. The dome 2016 resists up to a predetermined pressure of the fluid and can reverse abruptly such that its concave side reverses. In case of reversal, the dome 2016 and the area of least resistance 2026 undergo significant deformations that cause ruptures in the dome 16 and/or in the area of least resistance 2026. The ruptures caused are sufficient to allow the water for preparing a drink to enter the capsule. The reversal pressure of the dome 2016 can be calibrated easily, which allows precise control of the inlet pressure of the water, and consequently the extraction quality of the substance contained in the capsule 2002.

The drawn in tubular portion 2020 stiffens the peripheral region 2018 of the inlet wall 2008, which makes it possible to concentrate deformations in the dome 2016 and the area of least resistance 2026.

The outlet wall 2010 is attached on the side wall 2006. The outlet wall 2010 and the inner surface 2028 of the side wall 2006 comprise complementary raised snapping portions making it possible to snap the outlet wall 2010 in the front end of the side wall 2008.

As illustrated in FIGS. 23 and 24, the outlet wall 10 has a discoid shape. The outlet wall 2010 comprises a peripheral frame 2030 and a filter 2032 extending through the frame 2030 and comprising orifices 2034 for the passage of the water.

The raised snapping portions comprise an annular fastening rib 2036 and a company complementary annular fastening groove 2038, one of which is provided on the side wall 2006 and the other of which is provided on the frame 2030. The fastening rib 2036 is provided to snap in the fastening groove 2038. The fastening rib 2036 is formed on the edge 2040 of the frame 2030 and the fastening groove 2038 is formed in the inner surface 2028 of the side wall 2006.

The frame 2030 is self-supporting so as to retain its shape and ensure snapping of the outlet wall 2010 in the side wall 2006. The frame 2030 protrudes forward relative to the front end of the body 2004, and in particular relative to the rim 2012. Thus, the frame 2030 can bear against a support of an extraction device.

The frame 2030 is thicker than the filter 2032. The filter 2032 is thus positioned set back toward the inside of the capsule 2002 relative to the outer front face 30A of the frame 2030 turned toward the outside of the capsule the side wall 2006. This prevents the filter 2032 from tearing against raised portions of a support of an extraction device capable of receiving the capsule 2002.

The orifices 2034 are small enough to retain the substance, numerous enough to allow the prepared drink to pass, and preferably distributed on the surface of the filter 2032 to ensure correct extraction of the substance.

As shown in FIG. 23, the frame 2030 and the filter 2032 are integral. They are for example made from an injection-molded plastic material.

In one alternative illustrated in FIG. 25, the frame 30 is attached on the filter 2032. The frame 2030 is for example overmolded on the filter 2032, preferably on the marginal region of the filter 2032. The marginal region of the filter 2032 is embedded in the thickness of the frame 2030.

The filter 2032 is for example formed by a filter, a pierced film or a fabric. The filter 2032 is made from a plastic material, natural, synthetic or metal fibers, or a metal. The filter 2032 is for example a pierced aluminum film.

The frame 2030 is for example made from a pressurized injected plastic. A plastic material forming the frame 2030 is for example different from a plastic material forming the filter 2032. The frame 2030 is made from a plastic material making it possible to obtain a self-supporting rigid frame.

In an alternative illustrated in FIG. 26, the outlet wall 2010 comprises reinforcing crosspieces 2041 extending transversely across the frame 2030. The reinforcing crosspieces 2041 are integral with the frame 2030. Reinforcing crosspieces 2041 are provided on the outer face of the filter 2032 turned toward the outside of the capsule 2002 and/or the inner face of the filter 2032 turned toward the inside of the capsule 2002.

As shown in FIG. 26, the reinforcing crosspieces 2041 form an X. Alternatively, the reinforcing crosspieces are arranged differently.

The outlet wall 2010 can be obtained easily at a low cost. Its calibrated orifices 2034 make it possible to control the outlet pressure of the drink. The capsule 2002 is manufactured easily by filling the body 2004 with the substance, then fastening the outlet wall 2010 mechanically on the body 2004 by simple clipping of the outlet wall 2010 in the side wall 2006. This fastening operation is simple, reliable and easy to industrialize on a large scale. The clipping makes it possible to compress the substance.

The rim 2012 is attached on the side wall 2006. The rim 2012 surrounds the open front end of the side wall 2006 of the body 2004. The rim 12 extends radially toward the outside from the outer surface 2042 of the side wall 2006. It does not support any attached sealing element or deformable raised sealing element.

As shown in FIG. 23, the outer surface 2042 of the side wall 2006 defines, near the front end, an annular recess 2044 in which the inner border 2046 of the rim 2012 is engaged. The rim 2012 is fastened on the side wall 2006 without extending in the chamber 2018 and without being in contact with the substance contained in the capsule 2002.

Preferably, the rim 2012 is overmolded on the front end of the side wall 2006.

Preferably, the side wall 2006 and the inlet wall 2008 are made from a first airtight and watertight plastic material. The first plastic material is chosen to be inert with respect to the substance contained in the capsule 2002. The mass of the first material may be translucent or colored. Preferably, the first plastic material is a plastic or an alloy of plastics that does not interfere with food products and constitutes a high-performance barrier to air and water.

Preferably, the rim 2012 is made from a second plastic material, different from the first plastic material. The second plastic material is chosen to be a low-cost material. The second plastic material is for example a thermoplastic elastomer (TPE) or polyurethane (PU), which are inexpensive materials.

Preferably, the first and second plastic materials are compatible materials, i.e., materials suitable for polymerizing with each other. Thus, it is possible to produce capsules 2002 at a reduced cost. These capsules being designed to be produced in very large series, this makes it possible to achieve significant savings.

The mass of the second material may be colored. Thus, it is possible to color the rims 2010 of capsules 2002 containing different substances in different colors, so as to distinguish easily between a capsule 2002 containing a first substance and another capsule 2002 containing a second substance different from the first.

The capsule 2002 comprises a sealing membrane 2050 covering the outlet wall 2010 to sealably close the capsule 2002 at the front end of the side wall 2006. The membrane 2050 is fastened on the rim 2012 without being fastened on the outlet wall 2010.

The membrane 2050 is strippable so that it can be removed before use by a user. Alternatively, the membrane 2050 is provided to tear under the effect of a pressurized fluid. In that case, it for example comprises weakening lines.

The capsule 2002 is shown in FIG. 27 inserted in a drink extraction device 2060. This extraction device 2060 comprises a housing 2062 for receiving the capsule 2002 and a pressurized water intake line 2064 emerging in said the housing 2062. The housing 2062 has a shape complementary to that of the capsule 2002. The line 2064 emerges in the capsule 2002 near the inlet wall 2008. The housing 2062 has a support 66 against which the front end of the capsule 2002 bears. The support 2066 comprises at least one orifice 2068 for evacuating the drink.

During operation, the membrane 2050 is removed and the capsule 2002 is inserted in the housing 2062. Pressurized water is brought into the housing 2062. The pressurized water exerts pressure on the dome 2016. In return, the dome 2016 biases the area of least resistance 2026 axially in traction and radially in shearing. The area of least resistance 2026 breaks under the effect of the pressure from the water. The water passes through the substance contained in the capsule, then leaves through the outlet wall 2010 through the filter 2032.

In the case of a sudden-acting dome, the dome 2016 can reverse when the reversal pressure of the dome 2016 is reached and the inlet wall 2008 breaks.

The frame 2030 of the outlet wall 2010 bears on the support 2066 and is not dislodged from the side wall 2006 under the effect of the pressure from the water. The filter 2032 is set back toward the inside of the capsule 2002 relative to the frame 2030 and does not tear on the support 2066. As a result, the outlet conditions of the drink, which depend in particular on the number of orifices 2034 and their cross-section, are controlled.

The invention applies to capsules for extracting a pressurized coffee and capsules for extracting other pressurized drinks, such as tea, hot chocolate, etc. Thus, the invention generally relates to a capsule for extracting a pressurized drink.

It will be noted that the description provided above is in no way restricted, and the features of the different alternatives in the different embodiments may be combined with each other without going beyond the scope of the invention.

1. A capsule (2002) for extracting a drink under pressure, comprising:
a side wall (2006) extending along an axis (X-X),
an inlet wall (2008) closing a first end of the side wall (2006) and
an outlet wall (2010) closing a second end of the side wall (2006), delimiting a receiving chamber (14) for receiving a substance for preparing a drink, wherein the outlet wall (2010) and the inner surface (2028) of the side wall (2006) comprise complementary raised snapping portions for fastening the outlet wall (2010) on the side wall (2006).

2. The capsule according to claim 1, wherein the outlet wall (2010) comprises an annular fastening rib provided on an edge (2040) of the outlet wall (2010) and the inner surface (2028) of the side wall (206) comprises a complementary fastening groove (2038).

3. The capsule according to claim 1, wherein the outlet wall (2010) comprises a peripheral fastening frame (2030) and a filter (2032) extending through the frame (2030).

4. The capsule according to claim 3, wherein the filter (2032) comprises orifices (34).

5. The capsule according to claim 3, wherein the frame (2030) and the filter (2032) are integral.

6. The capsule according to claim 3, wherein the frame (2030) is attached on the filter (2032).

7. The capsule according to claim 6, wherein the frame (2030) is overmolded on a marginal region of the filter (2032).

8. The capsule according to claim 3, wherein the frame (2030) is thicker than the filter (2032).

9. The capsule according to claim 3, wherein the filter (2032) is set back toward the inside of the capsule (2002) relative to an outer face (2030A) of the frame (2030).

10. The capsule according to claim 1, wherein the inlet wall (208) is provided to break under the effect of a pressurized fluid.

11. The capsule according to claim 10, wherein the inlet wall (208) comprises a dome (2016) whereof the concave side is turned toward the inside of the capsule and an area of least resistance (2026) on the periphery of the dome (2016) provided to break under the effect of a pressurized fluid.

12. The capsule according to claim 11, wherein the dome (2016) is sudden-acting and can reverse abruptly under the effect of a pressurized fluid.

13. The capsule according to claim 11, wherein the dome (2016) is positioned set back toward the inside of the capsule (2002) relative to a peripheral portion (2020) of the inlet wall (208).

14. The capsule according to claim 11, wherein the dome (2016) extends transversely to the axis (X-X) and the area of least resistance (2026) extends axially along the axis (X-X).

15. The capsule according to claim 1, comprising an annular rim (2012) surrounding the second end of the side wall (2006) and extending radially toward the outside from the second end of the side wall (2006), the side wall (2006) and the inlet wall (208) being integral and made from a first material, and the rim (2012) being made from a second plastic material, different from the first plastic material.

16. A system, comprising:
a capsule comprising a side wall (2006) extending along an axis (X-X), an inlet wall (2008) closing a first end of the side wall (2006) and an outlet wall (2010) closing a second end of the side wall (2006), delimiting a receiving chamber (14) for receiving a substance for preparing a drink, wherein the outlet wall (2010) and the inner surface (2028) of the side wall (2006) comprise complementary raised snapping portions for fastening the outlet wall (2010) on the side wall (2006),
an extraction device (2060) including a housing (2062) designed to receive the capsule (2002) and an intake line (2064) for bringing pressurized extraction liquid into the housing.
